(19) United States
(12) Patent Application Publication
(10) Pub. No.: US 2010/0330267 A1
(43) Pub. Date: Dec. 30, 2010

(54) METHOD FOR PRODUCING ELECTRODE PLATE FOR BATTERY

(76) Inventors: Kyoushige Shimizu, Osaka (JP); Kenichi Oshima, Hyogo (JP); Hideo Hori, Osaka (JP)

Correspondence Address: MCDERMOTT WILL & EMERY LLP, 600 13TH STREET, NW, WASHINGTON, DC, 20005-3096, US

(21) Appl. No.: 12/918,618

(22) PCT Filed: Sep. 25, 2009
(86) PCT No.: PCT/JP2009/004861

§ 371 Date: Aug. 20, 2010

(30) Foreign Application Priority Data
Sep. 26, 2008 (JP) 2008-247629

(51) Int. Cl. B05D 5/12

(52) U.S. Cl. 427/77

(57) ABSTRACT

A production method of the present invention includes steps of: (a) obtaining a first electrode plate precursor 1 by applying an electrode active material onto at least one of surfaces of a long strip-shaped current collector so as to form an active material layer, (b) rolling an electrode plate precursor so that the active material layer has a predetermined thickness, and (c) obtaining plural strips of electrode plates by cutting the rolled electrode plate precursor to a desired width. In the step (a), non-application portions onto which an active material is not applied are formed on both edges of the electrode plate precursor in the width direction. The step (d) of removing the non-application portions is carried out simultaneously with the step (c). Accordingly, it is possible to improve production efficiency and reduce material losses by decreasing quality defects that occur in the step of rolling the electrode plate precursor.

### TECHNICAL FIELD

The present invention relates to a method for producing an electrode plate for a battery, and more particularly to an improvement in a method for producing an electrode plate for a battery in which an active material is applied onto a strip-shaped current collector, and the current collector is cut to a desired size.

### BACKGROUND ART

In recent years, electric devices, such as audiovisual devices, personal computers, and portable communication devices, have become portable and cordless at an increasing rate. Conventionally, aqueous batteries, such as nickel-cadmium batteries and nickel-metal hydride batteries, have been mainly used as power sources for driving such electric devices. However, in recent years, for the batteries used as these power sources, non-aqueous electrolyte batteries, which are represented by lithium ion secondary batteries that can be quickly charged, and that have both a high volume energy density and a high weight energy density, are becoming mainstream. On the other hand, the above nickel-cadmium batteries and nickel-metal hydride batteries are used as power sources for driving cordless power tools and electric vehicles that need high load characteristics, and thus there has been a demand for those batteries to have much higher capacity and larger current discharge characteristics.

Electrode plates for various batteries described above are normally produced by applying a pasty material mixture containing an electrode active material (hereinafter, referred to as a material mixture paste) onto a current collector made of a long strip-shaped metal foil or porous metal plate, and drying it so as to form an active material layer. The current collector on which the active material layer has been formed (hereinafter, a current collector on which an active material layer has been formed is referred to as an electrode plate precursor) is rolled, for example, with rollers so as to have a predetermined thickness, is thereafter subjected to slit processing so as to have a predetermined width, and is cut so as to have a predetermined length, thereby producing an electrode plate for a battery.

Here, as shown in FIGS. 7 to 9, there are some modes of a method for applying a material mixture paste to form an active material layer on a current collector.

In FIG. 7, one active material layer 32 is formed by uniformly applying a material mixture paste onto a current collector 31.

In FIG. 8, a material mixture paste is intermittently applied in a longitudinal direction of the current collector 31. Thereby, plural active material applied portions 32A are formed such that the active material applied portions 32A are aligned in the longitudinal direction of the current collector 31 at a predetermined pitch, with an active material non-applied portion (second non-application portion) 33 interposed therebetween. The active material layer 32 includes the plural active material applied portions 32A (so-called intermittent coating).

In FIG. 9, a material mixture paste is independently applied, so as to make a stripe, to each region obtained by dividing the current collector 31 into three regions in its width direction. Thereby, three lines of application portions 32B are formed so as to align in the width direction of the current collector 31. The active material layer 32 is constituted from the plural active material applied portions 32B (so-called stripe coating).

In any of these modes, active material non-applied portions (first non-application portions) 35 are formed on both edges of the current collector in the width direction. The reason for forming the first non-application portions on both edges of the current collector in the width direction is that there is a limit to the accuracy of an application position since there are cases where a long strip-shaped current collector snakes slightly when applying a paste that is mainly composed of an active material, while feeding the current collector in the longitudinal direction. Further, there is also a possibility that the paste that has been applied overflows in the width direction due to slump (a state where the shape of applied paste cannot be maintained due to low viscosity or low thixotropy), for instance.

In recent years, the density of the active material that has been applied is further increased by increasing a pressing force in the above rolling step in order to increase the battery capacity. Deformation of the electrode plate precursor in the above rolling step is allowable if the deformation is a uniform deformation in which the thickness is decreased due to uniform extension in the plane direction; however, if it is not, deformation leads to various faults and quality defects.

For example, defects are caused, such as “curving”, which is a state where either front or back surface of the electrode plate precursor after being rolled becomes convex, and “wrinkling”, which is a state where irregular unevenness occurs on the current collector of the electrode plate precursor after being rolled. The occurrence of defects, such as curving and wrinkling, to the electrode plate precursor also causes difficulty when winding the electrode plate precursor after being rolled in a coiled form.

Here, it seems that the main cause of the electrode plate precursor not uniformly extending in the plane direction is that an active material applied portion and a non-application portion exist on the electrode plate precursor, as described above. For example, in the case of rolling a strip-shaped electrode plate precursor by causing it to pass through between a pair of rollers while feeding it in the longitudinal direction, pressure is applied only to the active material applied portion, and almost no pressure is applied to the first non-application portion. Thus, if there is a difference between pressure applied to the active material applied portion of the electrode plate precursor and that to the non-application portion thereof, difference in extension between these two portions occurs, and such a difference in the extension may cause wrinkling and cutting in the boundary portion between the application portion and the non-application portion.

In addition, even in the case where the deformation due to rolling is a deformation only in the plane direction of the electrode plate precursor, if the deformation is not uniform between both edges in the width direction, “warping” occurs, which is a state where the electrode plate precursor after being rolled is laterally flexed. If such warping occurs, when forming an electrode plate group by spirally winding an electrode plate for a battery produced through the above slit processing and the like, “winding slippage” occurs, which is a state where the electrode plate shifts in the axial direction of a winding core. Further, if a binding force of the active material applied onto the current collector cannot follow the extension of the current collector due to rolling, “cracking” occurs on the surface of the active material layer. The active material applied on the electrode plate for a battery produced by cutting the electrode plate precursor on which wrinkling and cracking have occurred easily becomes detached. Therefore, production of a battery using such an electrode plate for a battery may result in serious quality defects, particularly in the case of a lithium ion secondary battery.

As described above, an electrode plate precursor is rolled in the state of having both an application portion onto which an active material has been applied and a non-application portion, which causes the occurrence of various defects. Accordingly, various countermeasures for avoiding such defects are carried out.

For example, as disclosed in Patent Document 1, before performing a rolling step, non-application portions (first non-application portions) on both edges of an electrode plate precursor in the width direction are removed in advance.

Moreover, it is necessary to stem a paste containing an active material so that the paste does not overflow in the width direction of a current collector when applying the active material onto the current collector. To achieve this, it is necessary to adjust the viscosity and thixotropy of the material mixture paste. If the viscosity and thixotropy of the material mixture paste are thus adjusted, both edges of the active material layers 32 in the width direction may rise as shown in FIG. 10. In this case, stress may be concentrated on these portions during rolling, which may cause the occurrence of cutting in the current collector. Accordingly, as disclosed in Patent Document 2, not only the active material non-applied portions (first non-application portions), but also both edges of the application portions are removed.

On the other hand, when applying an active material, in the case where a paste containing an active material with high flowability is applied, the cross section in the width direction after applying the paste often shows a shape in which the thickness becomes thinner as approaching both edges, as shown in FIG. 11. In the case where the electrode plate precursor having such a shape is rolled, and is thereafter subjected to slit processing so as to have a desired width, and thereby electrode plates for batteries are produced, the electrode plates for batteries that are cut out from both edges tend to have warping.

Furthermore, a tensile force added to the electrode plate precursor when rolling the electrode plate precursor has great influence on the rate of occurrence of wrinkling and cutting. Specifically, if the tensile force applied to the current collector is too large, distortion will occur. If the electrode plate precursor is rolled with the current collector being distorted, there is a high possibility that the distortion will be fixed as wrinkles, which is a plastic deformation. In this regard, Patent Document 3 proposes that slack is given to an electrode plate precursor in front of and behind pressure rollers, thus preventing a large tensile force from being applied to the electrode plate precursor during rolling.

As shown in FIG. 8, in the case where the active material applied portions 32A are intermittently formed in the longitudinal direction of an electrode plate precursor, it is known that, when pressure rollers move over the boundary between the active material applied portion 32A and the non-application portion (second non-application portion) 33, a shock occurs, and thus cutting easily occurs, particularly in the four corners of the active material applied portion 32A. If the occurred cutting is large, the electrode plate precursor may rupture, and a great production loss is caused in such a case.

In the case of rolling the electrode plate precursor on which the active material layer is intermittently formed in the longitudinal direction, the non-application portions (first non-application portions) 35 on both edges of the active material non-applied portion (second non-application portion) 33, which is shown in FIG. 8, adhere to pressure rollers, and the non-application portions that adhere thereto may be damaged. The cause is that the area of the pressure roller corresponding to the active material applied portion 32A becomes worn out, so that the area corresponding to the non-application portion (first non-application portion) 35 relatively protrudes. In such a case, if rolling is continued using the pressure roller whose circumferential surface has a fragment of the current collector adhering thereto, an accident, such as the pressure roller being damaged, is caused.

In order to prevent drawbacks described above in the case where the active material layer is intermittently formed in the longitudinal direction of the electrode plate precursor, a spacer is also used for pressure rollers (see Patent Document 4). Further, pressure rollers are provided in plural stages, and a pressing force applied by the pressure rollers in each stage is decreased, so that plastic deformation of the current collector due to rolling is advanced gradually (see Patent Documents 5 and 6).

### PRIOR ART DOCUMENT

### Patent Document

Patent Document 1: Japanese Laid-Open Patent Publication No. Hei 5-47375

Patent Document 2: Japanese Laid-Open Patent Publication No. Hei 11-176424

Patent Document 3: Japanese Laid-Open Patent Publication No. 2001-118753

Patent Document 4: Japanese Laid-Open Patent Publication No. 2000-133251

Patent Document 5: Japanese Laid-Open Patent Publication No. 2004-311296

Patent Document 6: Japanese Laid-Open Patent Publication No. Hei 8-192090

### SUMMARY OF THE INVENTION

### Problem to be Solved by the Invention

As disclosed in Patent Documents 1 and 2, conventionally, in order to prevent various defects described above, it was necessary to remove, in advance, the non-application portions (first non-application portions) on both edges of the electrode plate precursor in the width direction before a rolling step. In Patent Document 2, not only the non-application portions, but also both edge portions of the electrode plate precursor including both edges of the application portions are removed before a rolling step. However, in this case, apart from a cutting step (slit processing) of cutting the electrode plate precursor to a predetermined width, a so-called “trimming step” is interposed between a drying step and a rolling step, and thus production efficiency falls. Further, if a step of removing both edge portions of the electrode plate precursor in the width direction is interposed before a rolling step, cutting dust may be pressed into the active material layer in the subsequent rolling process, and thus a voltage failure may be caused after a battery is produced. Further, if the width removed by performing trimming is large, the loss of raw materials becomes large by that extent.

As disclosed in Patent Document 3, if slack is given to an electrode plate precursor before and after rolling to prevent a tensile force from being applied to the electrode plate precursor in front of and behind the pressure rollers during rolling, the extension of the current collector in the width direction due to rolling becomes large. As a result, in a cutting step (slit processing) of cutting an electrode plate precursor to a desired width, the amount of the material for both edge portions of the electrode plate precursor to be removed increases. Further, it becomes difficult to control the size of the electrode plate precursor in the width direction. Moreover, it becomes difficult to prevent the current collector from snaking, which tends to occur when the electrode plate precursor passes through pressure rollers.

As disclosed in Patent Document 4, the arrangement of a spacer between pressure rollers certainly prevents a shock that occurs when pressure rollers move over the boundary between the active material applied portion 32A and the non-application portion (second non-application portion) 33, which is shown in FIG. 8, and adhesion of the non-application portions (first non-application portions) 35 to the pressure rollers. However, for a lithium ion secondary battery whose thickness of an electrode plate precursor including an active material applied portion is at most 300 μm, a desired pressing force cannot be obtained if a spacer is used. For this reason, recently, a spacer is not used in many cases.

The present invention has been conceived in the light of the above problems, and it is an object thereof to provide a method for producing an electrode plate for a battery with which production efficiency can be improved by decreasing quality defects that occur in a step of rolling an electrode plate precursor, and also material losses can be further reduced by reducing the amount of the material to be discarded.

### Means for Solving the Problem

The present invention provides a method for producing an electrode plate for a battery, including steps of:

(a) producing a first electrode plate precursor by applying an electrode active material onto at least one of surfaces of a long strip-shaped current collector so as to form an active material layer, and also forming first non-application portions on which the electrode active material is not applied on both edges of the current collector in a width direction of the current collector;

(b) rolling the first electrode plate precursor so as to have a predetermined thickness;

(c) obtaining plural strips of second electrode plate precursors by cutting the rolled first electrode plate precursor to a predetermined width; and

(d) removing at least a portion of the first non-application portions,

wherein the step (d) is simultaneously carried out with the step (c).

### EFFECT OF THE INVENTION

According to the present invention, the step (d) of removing the first non-application portions onto which an electrode active material is not applied, which is provided in connection with carrying out the step (a) of applying the above active material to at least one surface of a long strip-shaped current collector so as to form an active material layer, is carried out simultaneously with the step (c) of cutting the electrode plate precursor that has been rolled to obtain plural strips of electrode plates having a desired width. Thereby, the number of steps can be decreased, and the efficiency of producing electrode plates for batteries can be improved. Further, material losses can be reduced by reducing the material for an electrode plate precursor to be removed in the above step (d). Furthermore, it is possible to reduce the occurrence of quality defects, such as wrinkling and cutting that occur in the step of rolling the electrode plate precursor.

### BRIEF DESCRIPTION OF THE DRAWINGS

FIG. 1 is a perspective view showing an example of an apparatus for rolling an electrode plate precursor to which the present invention is applied.

FIG. 2 shows a graph showing the rates of occurrence of wrinkling defects in Examples and Comparative Examples of the present invention.

FIG. 3 is a transverse cross-sectional view of the electrode plate precursor on which an active material layer has been formed such that both edges in the width direction are flat up to the vicinity of non-application portions.

FIG. 4 is a side view schematically showing a different example of a rolling apparatus for carrying out a method for producing an electrode plate for a battery according to another example of the present invention.

FIG. 5 is a front view schematically showing the shape of a crown roller.

FIG. 6 is a front view schematically showing a concept of axis bending.

FIG. 7 is a perspective view of the electrode plate precursor on which the active material layer has been uniformly formed.

FIG. 8 is a perspective view of the electrode plate precursor on which the active material layer has been intermittently formed in the longitudinal direction.

FIG. 9 is a perspective view of the electrode plate precursor on which the active material layer has been formed in a divided manner in the width direction.

FIG. 10 is a transverse cross-sectional view of the electrode plate precursor on which the active material layer has been formed such that both edges in the width direction rise.

FIG. 11 is a transverse cross-sectional view of the electrode plate precursor on which the active material layer has been formed such that both edges in the width direction are thinner.

### MODE FOR CARRYING OUT THE INVENTION

The present invention relates to a method for producing an electrode plate for a battery, including steps of: (a) producing a first electrode plate precursor by applying an electrode active material onto at least one of surfaces of a long strip-shaped current collector so as to form an active material layer, and also forming first non-application portions on which the electrode active material is not applied on both edges of the current collector in a width direction of the current collector; (b) rolling the first electrode plate precursor so as to have a predetermined thickness; (c) obtaining a plurality of strips of second electrode plate precursors by cutting the rolled first electrode plate precursor to a predetermined width; and (d) removing at least a portion of the first non-application portions. Here, the step (d) of removing the first non-application portions is simultaneously carried out with the step (c).

Accordingly, the step (d) of removing the first non-application portions is not performed before the step (b) of rolling the electrode plate precursor, but simultaneously carried out with the step (c) of cutting the electrode plate precursor so as to obtain plural strips of electrode plates having a desired width, which is after the step (b). Thus, the number of steps is reduced, and an increase in production efficiency can be achieved.

The present invention exhibits further remarkable effects by being applied to the case where the step (b) is carried out such that the first electrode plate precursor is caused to pass through between at least one pair of rollers disposed parallel to each other while being fed longitudinally. That is because it is efficient to carry out a rolling process with rollers in consideration of the shape of the electrode plate precursor, and also the present invention can effectively suppress faults that occur in the case of continuously rolling the electrode plate precursor using rollers.

Here, it is preferable that a greater tensile force is given to a first portion of the first electrode plate precursor that is fed longitudinally, the first portion being in front of a portion that is rolled with the at least one pair of rollers, compared to a tensile force given to a second portion of the first electrode plate precursor that is fed longitudinally, the second portion being behind the rolled portion.

Extension of the electrode plate precursor in the width direction due to rolling can be absorbed in the extension in the longitudinal direction by giving a greater tensile force before rolling. Specifically, in the case where a long strip-shaped current collector on which an active material layer has been formed, that is, an electrode plate precursor is rolled with a pair of rollers while being fed in the longitudinal direction, deformation due to rolling is concentrated on the position immediately before the position where the distance between the rollers is minimum. Here, if the electrode plate precursor is extended in the width direction because of the deformation due to rolling, in the step of removing the non-application portions on both edges of the electrode plate precursor in the width direction, which is carried out later, the position where cutting is performed moves inward in the width direction, resulting in an increase in material losses.

Therefore, it is preferable that the extension in the width direction is absorbed in the extension in the longitudinal direction due to deformation of the electrode plate precursor by making a tensile force given to the electrode plate precursor before rolling large in the range where the electrode plate precursor does not rupture.

It is preferable to give, to the electrode plate precursor after rolling, a comparatively small tensile force corresponding to an extent that is sufficient and necessary for suppressing snaking.

Here, the tensile force given to the electrode plate precursor is determined according to the material and thickness of the current collector, extensibility of the active material that has been applied, and the amount of deformation due to rolling that increases according to the magnitude of the pressing force, for instance.

It is more preferable to set the width of each of the first non-application portions to 2 mm or more and 8 mm or less.

Thus, by setting the width of each of the first non-application portions to 2 mm or more and 8 mm or less, which is smaller than the conventional width (conventionally, 10 mm or more), it is possible to remove the first non-application portions after the rolling step (step b) even in the production of an electrode plate for a battery, such as a positive electrode plate for a lithium ion secondary battery, for example, that requires a very large pressing force to compress an active material layer. This is because by setting the above width to 2 mm or more and 8 mm or less, it is possible to sufficiently decrease the rate of occurrence of quality defects, such as wrinkling, warping, and cutting, in the rolling step to a desired occurrence rate (see FIG. 2) even if rolling is performed without removing the first non-application portions.

Since the width of the first non-application portion that is removed in the step (c) is smaller, material losses are reduced. In addition, since the first non-application portion is removed after the rolling step, it is possible to avoid cutting dust generated through the removing being mixed in the active material layer. Therefore, it is possible to prevent quality defects such as a voltage failure from being caused.

FIG. 2 shows the relationship between the widths of the first non-application portion and the rates of occurrence of wrinkling defects in the case of rolling an electrode plate precursor for a positive electrode plate for a lithium ion secondary battery according to the present invention. The rate of occurrence of wrinkling defects in FIG. 2 represents the ratio of the length of a portion where defects occurred to the total length of the electrode plate precursor. Although details are described in Examples below, as shown in FIG. 2, by setting the width of the first non-application portion to 8 mm or less, the rates of occurrence of wrinkling defects can be extremely decreased. Further, along with this, the rates of occurrence of quality defects, such as cutting and breaking, can also be decreased very much. Here, the reason for setting the lower limit of the width of the first non-application portion to 2 mm is based on the consideration of the accuracy of a guiding mechanism for feeding an electrode plate precursor, and a possibility that a material mixture paste that is applied overflows onto both edges of the electrode plate precursor due to slump. Therefore, if such problems are solved, it is also possible to set the width of the first non-application portion to 2 mm or less.

Accordingly, if the width of the first non-application portion is made small, the occurrence of quality defects, such as wrinkling, can be reduced. That is because the cause of such quality defect occurrence is that the amounts of deformation of the electrode plate precursor during rolling are different between the active material applied portion and the first non-application portion. As described above, the amount of deformation of the electrode plate precursor is large in the active material applied portion, and in contrast, the electrode plate precursor hardly deforms in the active material non-applied portion. If there is no non-application portion, the stress due to the difference of the amounts of deformation will not be generated. In contrast, the stress generated between the non-application portion and the application portion becomes larger as the width of the first non-application portion becomes larger.

If the stress generated between the non-application portion and the application portion becomes large, wrinkling easily occurs to the electrode plate precursor, and if the stress becomes greater than a certain extent, cutting occurs. Therefore, occurrence of wrinkling can be suppressed by making the width of the first non-application portion small so that the stress generated between the non-application portion and the application portion is decreased. The wrinkling to the electrode plate precursor makes the active material layer easy to detach. Detachment of the active material layer causes a serious quality defect, particularly in the case of a lithium ion secondary battery with a high capacity. Therefore, since the electrode plate precursor to which wrinkling has occurred cannot be used for products, material losses can be reduced by suppressing the occurrence of wrinkling.

Here, preferably, the present invention is mainly applied to the case where a total width of the electrode plate precursor is 400 mm or more and 2000 mm or less. The reason for setting the total width to 400 mm or more is that the width of a current collector raw material sheet to which the present invention is assumed to be applied is ordinarily 400 mm or more. Also, the reason therefor is that a series of steps provides higher productivity as the total width is larger. That is, it is because productivity falls if the width of the electrode plate precursor is less than 400 mm.

On the other hand, the reason for setting the total width of the electrode plate precursor to 2000 mm or less is that if the total width is larger than this, it is difficult to uniformly apply an active material to the current collector, and thus a possibility that quality defects occur significantly increases. Besides, it is also necessary to increase the pressing force applied by rollers as the total width becomes larger, which leads to an increase of the size of the apparatus. Therefore, by setting the total width of the electrode plate precursor to 400 mm or more and 2000 mm or less, it is possible to improve the productivity of electrodes and also improve the quality.

Here, from a viewpoint of making stress distribution in the width direction on the electrode plate precursor bilaterally symmetrical during rolling, the first non-application portions preferably have an equal width. Accordingly, the quality of an electrode can further be improved. It is because if the amounts of deformation of the electrode plate precursor on both edges in the width direction are different, various defects, such as wrinkling and warping (particularly, warping defects) easily occur.

The present invention exhibits further remarkable effects by being applied to the case where the electrode plate precursor is formed such that active material applied portions are aligned in the longitudinal direction at a substantially equal pitch with a second non-application portion having a prescribed width interposed therebetween. In this way, if second active material applied portions are intermittently formed in the longitudinal direction of the electrode plate precursor, faults, such as wrinkling, cutting, and breaking, easily occur to the current collector due to a shock that occurs when rollers pass over the boundary between the application portion and the second non-application portion, and adhesion between the first non-application portion and a roller. The present invention can effectively suppress the occurrence of such faults.

In the step (b), it is preferable that the first electrode plate precursor is sequentially rolled with two or more pairs of rollers. Accordingly, the amount of rolling deformation required per pair of rollers can be decreased. As a result, the occurrence of defects, such as wrinkling and cutting, can be reduced. Thereby, the processing speed can also be increased.

In the above step (b), it is also preferable that the first electrode plate precursor is repeatedly rolled with a pair of rollers.

As having described in the section of Background Art, if it is necessary to compress an active material layer so as to increase its density, large pressure needs to be applied. In this case, a spacer cannot even be arranged between rollers. Therefore, by repeating the step of again rolling the electrode plate precursor that has been rolled once, a pressing force that is applied each time rolling is performed can be decreased, and the amount of deformation of the electrode plate precursor that is caused each time rolling is performed can be reduced. Therefore, the occurrence of quality defects, such as wrinkling and cutting, can be reduced. In addition, the step of repeating rolling of the first electrode plate precursor with a pair of rollers can be executed using the same machinery. Accordingly, it is not necessary to expand equipment for the rolling step, and thus increase in cost will not be caused.

In the above step of repeating rolling, each time rolling is performed with a pair of rollers, if the direction of feeding the first electrode plate precursor is reverted, it is also possible to achieve an effect of eliminating distortion occurred to the electrode plate precursor due to rolling.

Lubricating oil can be supplied to a portion where the at least one pair of rollers and the first non-application portion face each other, or a portion where the at least one pair of rollers and a boundary portion between the first non-application portion and the application portion face each other. Accordingly, a current collector can be prevented from adhering to a roller even if the first non-application portions on both edges of the second non-application portion and the circumferential surface of the roller are pressed against each other, for example.

If a current collector adheres to a roller, the adhesion portion is torn off, being stuck on the circumferential surface of the roller, which causes cutting defects, and when the tearing is significant, the electrode plate precursor ruptures at that portion. Further, if rolling is continued using the roller with a fragment of the torn-off current collector being stuck to the circumferential surface, an excessive force is applied to the roller, and the life of the roller becomes short. The shortening of the life of the roller due to this cause poses a very serious problem. The cause is eliminated by using lubricating oil, and thereby the average life of the rollers at a manufacturing site has extended by six times (from one month to six months).

As the lubricating oil herein, it is preferable to use lubricating oil that does not have harmful effects on the battery performance even if it enters into a battery. From such a viewpoint, preferably, the lubricating oil does not contain impurities, such as metal or metal ions, and easily volatilizes at normal temperature. For example, preferably, the lubricating oil is mainly composed of high purity hydrocarbon (fourth group, second class petroleum), and more preferably, it contains isoparaffinic hydrocarbon.

It is preferable that at least one roller selected from the at least one pair of rollers has a diameter that is larger in a center portion in an axial direction, and that gradually decreases toward both end portions in the axial direction. Further, it is also preferable that an axis of at least one roller selected from the at least one pair of rollers is bent such that the distance between the at least one roller and another roller that forms a pair becomes shorter in a center portion in an axial direction.

This is because in the rolling step, the stress due to compression performed with rollers tends to be concentrated on the boundary between the active material applied portion and the non-application portion of the first electrode plate precursor, and thus cutting easily occurs in that portion. In order to prevent the occurrence of such cutting, it is preferable that pressure is applied, in the axial direction, to at least one of the rollers that form a pair, that is, for example, an upper roller such that the center portion protrudes toward the opposing roller (hereinafter, referred to as axis bending). Further, it is also preferable that at least one of the rollers that form a pair has a shape in which the diameter is wide at a center portion, and becomes gently narrowed as approaching both end portions (hereinafter, referred to as a crown roller).

At this time, it is particularly effective to apply axis bending to at least one of the first rollers in the case of using two or more pairs of rollers. Further, it is particularly effective to apply a crown roller to at least one of the last rollers in the case of using two or more pairs of rollers.

The reason for using a crown roller for the last stage is that a crown roller has functionality of performing rolling while eliminating distortion (elastic deformation) that has occurred to the electrode plate precursor. That is, it is because there are many cases where distortion is fixed as wrinkles (plastic deformation) if rolling is performed in the last stage without eliminating distortion.

The reason for using axis bending to the roller in the first stage is that in the case of providing rollers in plural stages, ordinarily, the first rollers provide the largest rolling deformation amount, and also the largest pressing force.

In the case of using only one pair of rollers, axis bending and/or a crown roller may be used for at least one of the pair of rollers.

### EXAMPLES

Next, the present invention is more specifically described based on Examples and Comparative Examples. It should be noted that the present invention is not limited to these.

### Examples 1 to 4 and Comparative Examples 1 to 3

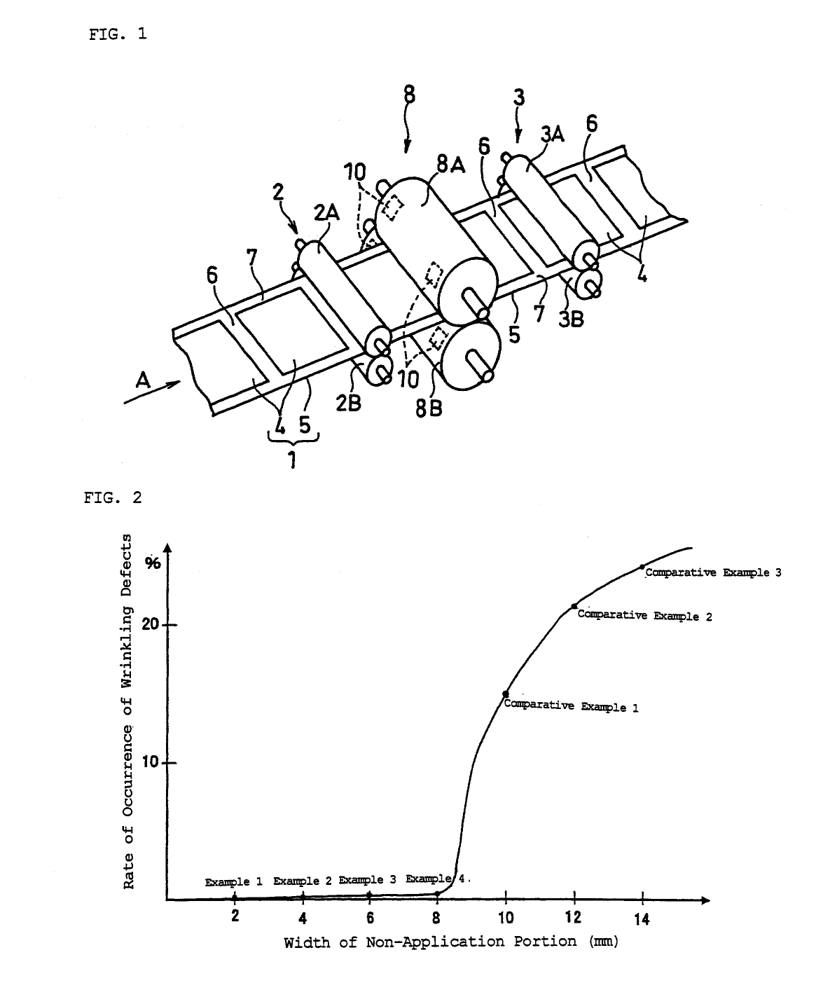

FIG. 1 is a perspective view showing a schematic configuration of a rolling apparatus used in Examples 1 to 4 of the present invention.

As shown in FIG. 1, the rolling apparatus includes pressure rollers 8 constituted by a pair of rollers 8A and 8B having a comparatively large diameter (diameter: 500 mm, width: 600 mm). The rollers 8A and 8B of the pressure rollers 8 are arranged one above the other and parallel to each other with a predetermined gap therebetween. A current collector 5 provided with an active material layer (active material applied portion) 4 on the surface, that is, a first electrode plate precursor 1 is caused to pass through between the rollers 8A and 8B while being fed in the longitudinal direction (shown by arrow A in FIG. 1). Thereby, the active material layer 4 is compressed, and thus the first electrode plate precursor 1 is rolled so as to have a predetermined thickness.

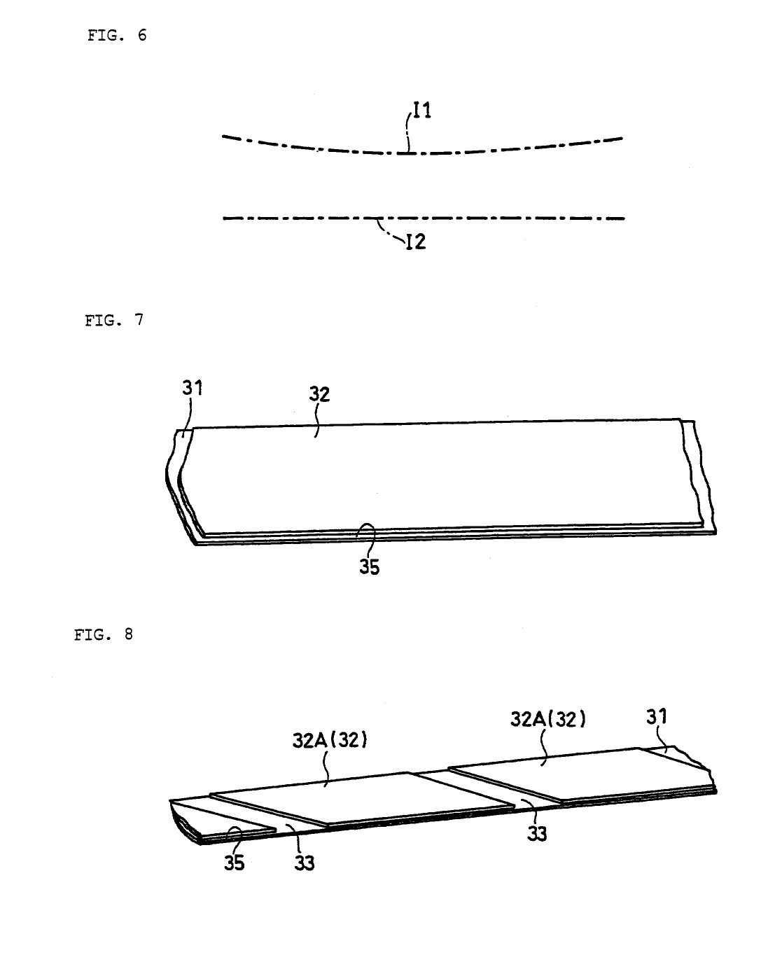

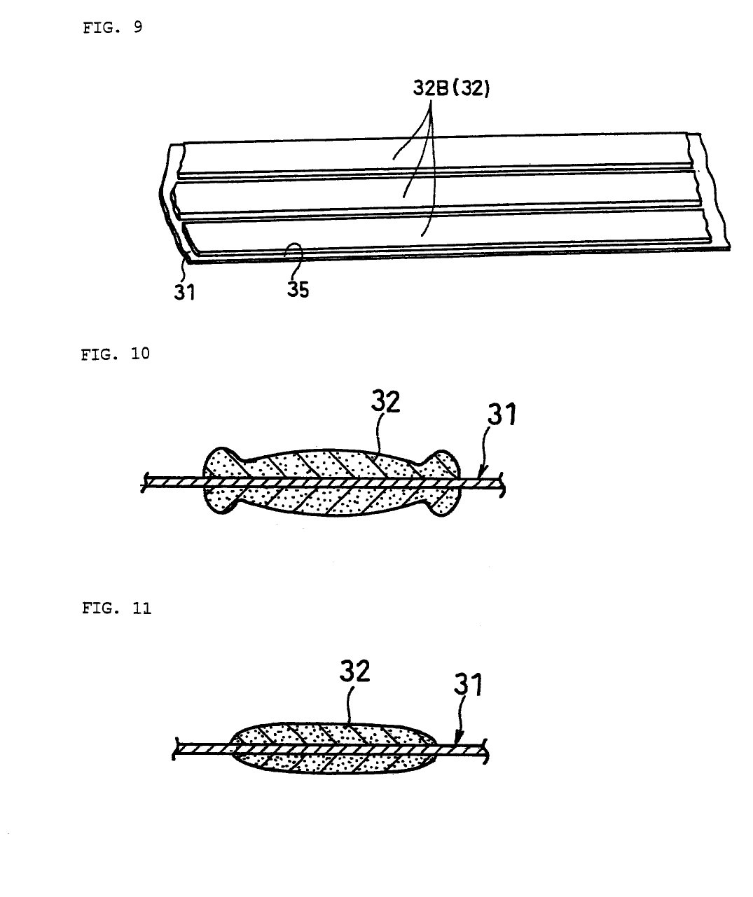

Here, the pressure rollers 8 are constituted by the rollers 8A and 8B both of which are crown rollers shown in FIG. 5, and axis bending shown in FIG. 6 is applied to both of the rollers 8A and 8B. A crown roller is a roller whose diameter in the center portion in the axial direction is the maximum, and diameter gradually decreases toward both ends from the center portion, as shown in FIG. 5. In FIG. 5, the roller 8A (8B) is rotatably supported by bearings 11, 12, 13, and 14. Further, in FIG. 5, the amount of change in the diameter of the roller 8A (8B) is magnified relative to the actual amount.

Axis bending is a technique with which pressure is applied to at least one of a pair of rollers in the axial direction, thereby bending the roller such that the distance between that roller and the other roller becomes shorter in the center portion in the axial direction, as shown in FIG. 6. In FIG. 6, the dashed dotted lines respectively show axes I1 and I2 of a pair of rollers. Further, in FIG. 6, bending of the axis of a pair of rollers is magnified relative to the actual bending.

Tension rollers (nip rolls) 2 and 3 are respectively disposed in front of and behind the pressure rollers 8 in the direction of feeding the first electrode plate precursor 1. The front tension rollers 2 arranged in front of the pressure rollers 8 in the above feeding direction are constituted by a pair of rollers 2A and 2B that have a comparatively small diameter (diameter: 120 mm, width: 600 mm). The front tension rollers 2 give a predetermined tensile force to the first electrode plate precursor 1 between the front tension rollers 2 and the pressure rollers 8 by the rotational speed of the rollers 2A and 2B being adjusted, which sandwich the first electrode plate precursor 1. Further, the rear tension rollers 3 that are arranged behind the pressure rollers 8 in the feeding direction are constituted by a pair of rollers 3A and 3B that have a comparatively small diameter (diameter: 120 mm, width: 600 mm). The rear tension rollers 3 give a predetermined tensile force to the first electrode plate precursor 1 between the rear tension rollers 3 and the pressure rollers 8 by the rotational speed of the rollers 3A and 3B being adjusted, which sandwich the first electrode plate precursor 1 that has been rolled. Further, the tension rollers 2 and 3 give a certain tensile force to the first electrode plate precursor 1 that is rolled with the pressure rollers 8, and thereby prevent the first electrode plate precursor 1 from snaking to the right and left.

In Examples 1 to 4 of the present invention, positive electrode plates for lithium ion secondary batteries were produced. Here, as the current collector 5, a long strip-shaped aluminum foil was used, whose width was 465 mm, thickness was 15 μm, and length of one roll was 1900 m. Further, a paste (material mixture paste) was prepared by dispersing an active material powder made of lithium cobaltate and the like, a conductive agent, a thickener, and a binder in a dispersion medium, the material mixture paste was applied onto both surfaces of the current collector 5 using a die coater (not shown), and the whole was dried, thereby forming the active material layers 4. The total thickness of the current collector 5 and the active material layers 4 after being dried, that is, the first electrode plate precursor 1 was 270 μm.

The material mixture paste was applied such that the active material layers (active material applied portions) 4 were formed in the longitudinal direction of the current collector 5 at a predetermined pitch. At this time, the material mixture paste was applied such that a non-application portion 6 having a width of 70 mm was interposed between one application portion and another adjacent application portion.

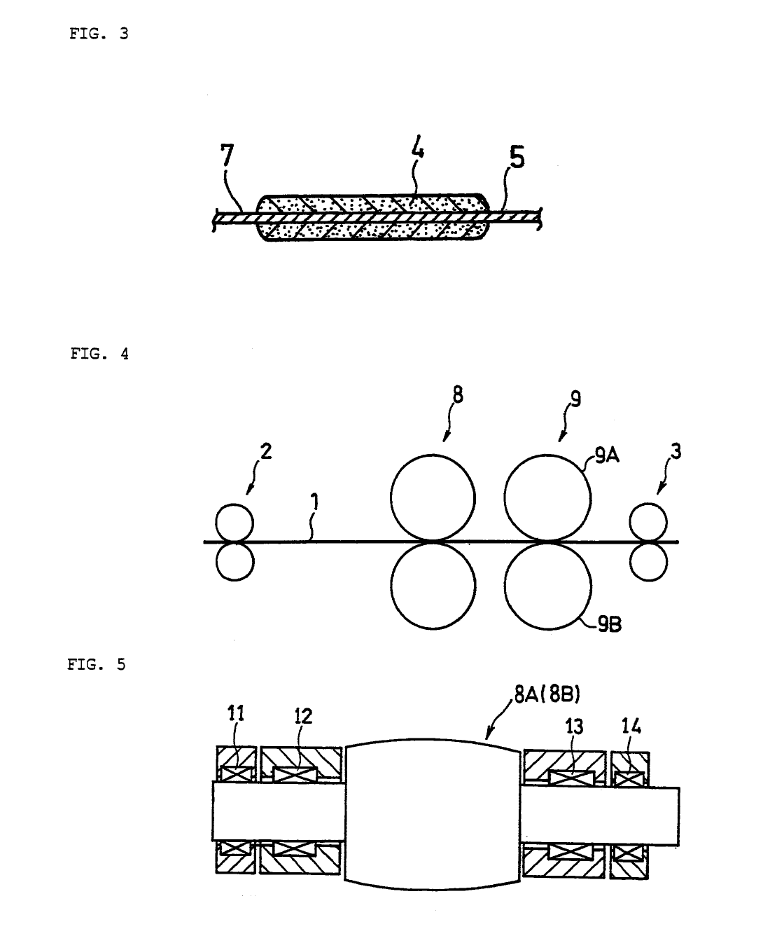

The first electrode plate precursor 1 was provided with first non-application portions 7 having the same width, on which an active material was not applied, on both edges in the width direction. Here, four types of the first electrode plate precursors 1 were prepared, being provided with the first non-application portions 7 having widths of 2 mm (Example 1), 4 mm (Example 2), 6 mm (Example 3) and 8 mm (Example 4), respectively. At this time, the opening width of the discharge orifice of the die coater, the viscosity of the material mixture paste, and the like were adjusted, and the active material was applied onto the current collector 5 such that the flat active material layers 4 were formed up to the vicinity of the first non-application portion 7, as shown in FIG. 3.

Then, the first electrode plate precursors 1 of Examples 1 to 4 described above were rolled until the total thickness thereof became about 200 μm with the rolling apparatus shown in FIG. 1. At this time, the rolling rate (rolling rate: the amount of decrease of the thickness of the active material applied portion due to rolling/the thickness of the active material applied portion before rolling) was 27.5%. At this time, the tensile force applied to the first electrode plate precursor 1 between the pressure rollers 8 and the front tension rollers 2 was set to 3.2 N/cm. Further, the tensile force applied to the first electrode plate precursor 1 between the pressure rollers 8 and the rear tension rollers 3 was set to 2.1 N/cm.

Volatile lubricating oil (Aqua Press GS-5 available from Aqua Chemical Co. Ltd.) was supplied to the portion where the pressure rollers 8 and the first non-application portion 7 faced each other. More specifically, the above volatile lubricating oil supplied from a supply pipe (not shown) via felt was applied to areas 10 in the vicinity of both end portions of the pressure rollers 8 facing the first non-application portion 7.

Then, the length of the portion to which wrinkling defects had occurred of the first electrode plate precursor 1 whose total length was 1900 m (there may have been some extension due to rolling) was measured, and the rate of occurrence of wrinkling defects was obtained by calculating the ratio of the length of the defective portion to the total length. Here, the length of the portion to which wrinkling had occurred was determined by visually observing the first electrode plate precursor 1 that had been rolled and wound by a winding reel (not shown). The rates of occurrence of wrinkling defects obtained for Examples 1 to 4 are shown in FIG. 2.

When rolling the first electrode plate precursor 1, the rolling process was carried out while inspecting cutting defects using an image sensor. As a result, in Examples 1 to 4 of the present invention, the occurrence of cutting defects was not found in the first electrode plate precursor 1 having a total length of about 1900 m.

The first electrode plate precursor 1 rolled as described above was cut into plural strips of second electrode plate precursors having a predetermined width. At this time, a removing step of removing the first non-application portions 7 was carried out simultaneously with the cutting process. The second electrode plate precursor was further cut to a predetermined length, and a positive electrode plate was obtained.

Using the same material as that in Examples 1 to 4, four types of the first electrode plate precursors 1 having a total thickness of 270 μm were prepared, being provided with the first non-application portions 7 having widths of 10 mm (Comparative Example 1), 12 mm (Comparative Example 2), and 14 mm (Comparative Example 3), respectively. The above first electrode plate precursors 1 were rolled using the rolling apparatus shown in FIG. 1 in the same manner as in Examples 1 to 4.

Then, the rates of occurrence of wrinkling defects were obtained in the same manner as in Examples 1 to 4. The rates of occurrence of wrinkling defects obtained for Comparative Examples 1 to 3 are shown in FIG. 2.

As shown in FIG. 2, in Comparative Examples 1 to 3 in which each of the first non-application portions 7 has a width larger than 8 mm, the rates of occurrence of wrinkling defects show a sharp increase as the width of the first non-application portion 7 becomes wider. In contrast, in Examples 1 to 4 above, the rates of occurrence of wrinkling defects show values almost close to zero. This result clearly shows the superiority of the present invention in which the width of each of the first non-application portions 7 is set to 2 to 8 mm.

In Comparative Examples 1 to 3 as well, when rolling the first electrode plate precursor 1, the rolling process was carried out while inspecting cutting defects using an image sensor in the same manner as in Examples 1 to 4. As a result, in Comparative Examples 1 to 3 of the present invention, the occurrence of cutting defects was found in several portions.

### Examples 5 to 8

Using the same material as that in Examples 1 to 4, four types of the first electrode plate precursors 1 were prepared, being provided with the first non-application portions 7 having widths of 2 mm (Example 5), 4 mm (Example 6), 6 mm (Example 7) and 8 mm (Example 8), respectively. Using the rolling apparatus shown in FIG. 1, the first electrode plate precursor 1 having a total thickness of 270 μm was rolled with the rollers 8 so that the total thickness became 210 μm. The rolling rate in this rolling process alone was 23.5%. The first electrode plate precursor 1 that had been wound by a winding reel (not shown) after having been rolled was rolled until the total thickness became 190 μm using the rolling apparatus shown in FIG. 1 again, while unwinding it from the reel with the front and back thereof being reversed. The rolling rate in this rolling process alone was 10.3%. Other than this, a positive electrode plate was produced in the same manner as in Examples 1 to 4. At this time, the total rolling rate was 31.4%.

Here, as the result of obtaining the rates of occurrence of wrinkling defects in the same manner as in Examples 1 to 4, almost no occurrence of wrinkling was found in Examples 5 to 8 of the present invention. It seems that the above result was due to a rolling rate in one rolling process in Examples 5 to 8 of the present invention being lower than that in Examples 1 to 4. It is because if the rolling rate is decreased, the rate of occurrence of defects due to rolling falls by the same extent or the extent greater than that.

When rolling the first electrode plate precursor 1, the rolling process was carried out while inspecting cutting defects using an image sensor. As a result, in Examples 5 to 8 of the present invention as well, the occurrence of cutting defects was not found in the first electrode plate precursor 1 having a total length of about 1900 m.

In Examples 5 to 8, since two rolling processes were performed, the time of the entire rolling step became longer than that in Examples 1 to 4. However, since the rolling rate in the first rolling process was able to be decreased by about 4% compared to that in Examples 1 to 4, the rate of occurrence of quality defects was able to be remarkably reduced. In addition, it was able to perform rolling with a greater rolling rate in total.

### Examples 9 to 12

As shown in FIG. 4, in Examples 9 to 12, a rolling apparatus was used in which downstream pressure rollers 9 constituted by a pair of rollers 9A and 9B have been added and arranged at a position that is downstream of the pressure rollers 8 and upstream of the rear tension rollers 3 of the apparatus shown in FIG. 1. Here, crown rollers (see FIG. 5) were used for the rollers 9A and 9B of the downstream pressure rollers 9.

Using the same material as that in Examples 1 to 4, four types of the first electrode plate precursors 1 having a total thickness of 270 μm were prepared, being provided with the first non-application portions 7 having widths of 2 mm (Example 9), 4 mm (Example 10), 6 mm (Example 11), and 8 mm (Example 12), respectively. Using the rolling apparatus described above, the first electrode plate precursors 1 were rolled with the pressure rollers 8 until the total thickness thereof became 210 μm (the rolling rate was 23.5%), and thereafter rolled with the downstream pressure rollers 9 until the total thickness became 190 μm (the rolling rate was 10.3%). At this time, the total rolling rate was 31.4%.

Here, as a result of having examined the occurrence of wrinkling defects and cutting defects in the same manner as in Examples 1 to 4, almost the same results as those in Examples 5 to 8 were able to be obtained. Further, since the rolling rates of rolling performed respectively with the pressure rollers 8 and the downstream pressure rollers 9 were lower in Examples 9 to 12 of the present invention than the rolling rate in Examples 1 to 4, the first electrode plate precursors 1 were able to be rolled at a faster speed. Thereby, productivity improved.

### Examples 13 to 16

In Examples 13 to 16 of the present invention, negative electrode plates for lithium ion secondary batteries were produced with the rolling apparatus used in Examples 1 to 4. At this time, as the current collector 5, a long strip-shaped copper foil was used, whose width was 1100 mm, thickness was 10 μm, and length of one roll was 1900 m. For the active material layer 4, a material mixture paste was prepared by dispersing an active material powder mainly made of graphite, a conductive agent, a thickener, and a binder in a dispersion medium. The material mixture paste was applied onto both surfaces of the current collector 5 using a die coater (not shown), and the whole was dried, thereby forming the active material layer 4. The total thickness of the current collector 5 and the active material layers 4 after being dried, that is, the first electrode plate precursor 1 was 150 μm.

The material mixture paste was applied such that the active material layers (active material applied portions) 4 were formed in the longitudinal direction of the first electrode plate precursor 1 at a predetermined pitch. At this time, the material mixture paste was applied such that the non-application portion 6 having a width of 90 mm was interposed between one application portion and another adjacent application portion.

The first electrode plate precursor 1 was provided with the first non-application portions 7 having the same width, on which the active material was not applied, on both edges in the width direction. Here, four types of the first electrode plate precursors 1 were prepared, being provided with the first non-application portions 7 having widths of 4 mm (Example 13), 6 mm (Example 14), 8 mm (Example 15), and 10 mm (Example 16), respectively. At this time, the opening width of the discharge orifice of the die coater, the viscosity of the paste, and the like were adjusted, and the active material was applied such that the flat active material layers 4 were formed up to the vicinity of the first non-application portion 7, as shown in FIG. 3.

Then, the first electrode plate precursors 1 of the Examples 13 to 16 described above were rolled until the total thickness became 130 μm (the rolling rate was 14.3%), and the first electrode plate precursors 1 for the negative electrode were produced. At this time, adjustment was made such that the tensile force applied to the first electrode plate precursor 1 between the pressure rollers 8 and the front tension rollers 2 was 3.5 N/cm, and the tensile force applied to the first electrode plate precursor 1 between the pressure rollers 8 and the rear tension rollers 3 was 2.3 N/cm.

Lubricating oil was not particularly supplied to the portions where the pressure rollers 8 and the first non-application portion 7 faced each other.

Then, the occurrence of wrinkling defects to the first electrode plate precursors 1 having a total length of 1900 m was examined in the same manner as in Examples 1 to 4. However, in any of Examples 13 to 16 described above, the occurrence of wrinkling defects was not found at all. Further, the occurrence of cutting defects was not found either, in Examples 13 to 16 described above.

It seems that the above results were obtained because in the production of negative electrode plates, graphite serving as an active material has good extensibility, and the rolling rates in Examples described above are also low, and thus wrinkling due to rolling did not occur even in the case where the width of the first non-application portion of the first electrode plate precursor 1 exceeded 8 mm. The restriction of the above non-application portion having a width of 2 mm or more and 8 mm or less is a condition for preventing the occurrence of wrinkling defects and the like even in a rolling process requiring a great pressing force, such as the case of rolling a positive electrode plate for a lithium ion secondary battery. Therefore, by satisfying this condition, the occurrence of wrinkling defects can be remarkably suppressed in the rolling of electrode plate precursors for all the batteries, including positive electrode plates for lithium ion secondary batteries.

### INDUSTRIAL APPLICABILITY

According to a method for producing an electrode plate for a battery of the present invention, it is possible to reduce the rate of occurrence of defects, such as wrinkling and warping that occur when rolling an electrode plate precursor, such as when compressing an active material layer, and thus the production efficiency of batteries can be improved.

### DESCRIPTION OF REFERENCE NUMERALS

1 Electrode Plate Precursor
8, 9 Pressure Roller
2, 3 Tension Roller
4 Active Material Layer (Active Material Applied Portion)
5 Current Collector
   6, 7 Non-Application Portion

1. A method for producing an electrode plate for a battery, comprising steps of:
(a) producing a first electrode plate precursor by applying an electrode active material onto at least one of surfaces of a long strip-shaped current collector so as to form an active material layer, and also forming first non-application portions on which said electrode active material is not applied on both edges of said current collector in a width direction of said current collector;
(b) rolling said first electrode plate precursor so as to have a predetermined thickness;
(c) obtaining a plurality of strips of second electrode plate precursors by cutting said rolled first electrode plate precursor to a predetermined width; and
(d) removing at least a portion of said first non-application portions,
wherein said step (d) is simultaneously carried out with said step (c).

2. The method for producing an electrode plate for a battery in accordance with claim 1, Wherein said step (b) comprises causing said first electrode plate precursor to pass through between at least one pair of rollers disposed parallel to each other while feeding said first electrode plate precursor longitudinally.

3. The method for producing an electrode plate for a battery in accordance with claim 2, wherein a greater tensile force is given to a first portion of said first electrode plate precursor that is fed longitudinally, said first portion being in front of a portion that is rolled with said at least one pair of rollers, compared to a tensile force given to a second portion of said first electrode plate precursor that is fed longitudinally, said second portion being behind said rolled portion.

4. The method for producing an electrode plate for a battery in accordance with claim 1, wherein each of said first non-application portions has a width of 2 mm or more and 10 mm or less.

5. The method for producing an electrode plate for a battery in accordance with claim 1, wherein said first electrode plate precursor has a width of 400 mm or more and 2000 mm or less.

6. The method for producing an electrode plate for a battery in accordance with claim 1, wherein said first non-application portions have an equal width.

7. The method for producing an electrode plate for a battery in accordance with claim 1, wherein said step (a) comprises forming, as said active material layer, application portions onto which said electrode active material has been applied such that said application portions are aligned at a substantially equal pitch in a longitudinal direction of said current collector, and forming a second non-application portion having a predetermined width onto which said electrode active material is not applied, between each pair of said application portions.

8. The method for producing an electrode plate for a battery in accordance with claim 2, wherein said step (b) comprises sequentially rolling said first electrode plate precursor with two or more pairs of rollers.

9. The method for producing an electrode plate for a battery in accordance with claim 2, wherein said step (b) comprises repeatedly rolling said first electrode plate precursor with said one pair of rollers.

10. The method for producing an electrode plate for a battery in accordance with claim 9, wherein a direction of feeding said first electrode plate precursor is reversed each time rolling is performed with said one pair of rollers.

11. The method for producing an electrode plate for a battery in accordance with claim 2, wherein lubricating oil is supplied to a portion where said at least one pair of rollers and said first non-application portion face each other, or a portion where said at least one pair of rollers and a boundary portion between said first non-application portion and said application portion face each other.

12. The method for producing an electrode plate for a battery in accordance with claim 11, wherein said lubricating oil is volatile oil.

13. The method for producing an electrode plate for a battery in accordance with claim 2, wherein at least one roller selected from said at least one pair of rollers has a diameter that is larger in a center portion in an axial direction, and that gradually decreases toward both end portions in said axial direction.

14. The method for producing an electrode plate for a battery in accordance with claim 2, wherein an axis of at least one roller selected from said at least one pair of rollers is bent such that a distance between said at least one roller and another roller that forms a pair becomes shorter in a center portion in an axial direction.
